(19) United States
(12) Patent Application Publication
(10) Pub. No.: US 2021/0341262 A1
(43) Pub. Date: Nov. 4, 2021

(54) ARMOR AND METHOD OF MANUFACTURE

(71) Applicant: Gigi Simovitch, Saviyon (IL)

(72) Inventor: Gigi Simovitch, Saviyon (IL)

(21) Appl. No.: 17/261,696

(22) PCT Filed: Jul. 25, 2019
(86) PCT No.: PCT/IL2019/050844

§ 371 Date: Jan. 20, 2021

(30) Foreign Application Priority Data
Aug. 5, 2018 (IL) 260998

(51) Int. Cl. F41H 5/04

(52) U.S. Cl. CPC F41H 5/0421; B32B 3/04

(57) ABSTRACT

An element using armor plating including a tile and a metal cover bonded to the tile by an adhesive in a manner so that the metal cover is arranged around a central face and a plurality of sides of the tile, and a non-adjacent face of the tile, thereby enclosing and confining the tile.

### PRIORITY INFORMATION

The subject patent application is a National Stage Entry of PCT/IL2019/050844, filed on Jul. 25, 2019, and claims priority from Israeli Patent Application No: 260998, filed on Aug. 5, 2018.

### BACKGROUND OF THE INVENTION

Armor plating is used to protect installations, vehicles, airplanes and ships from projectiles. Whilst a sufficiently thick layer of steel will stop most projectiles, there is a weight consideration which makes the use of steel plate inappropriate for vehicles. Although more costly, hard lightweight ballistic ceramics comprising materials such as alumina, aluminum nitride, silicon carbide and boron nitride have been found effective at stopping projectiles. However, such materials are brittle and not easily attached together. Several attempts have been made to provide scale type armor consisting of ceramic tiles on a backing plate of metal, or covered with metal. Having a metal layer between adjacent ceramic tiles has been found to be useful for stopping crack propagation, localizing the damage from impacts, and protecting the edges and corners of the relatively brittle ceramic tiles.

WO2009045584 titled “Method for Producing Armor through Metallic Encapsulation of a Ceramic Core” is directed to a sheet metal container design that allows for double encapsulation of individual hexagonally shaped ceramic tiles that can be adapted to different shapes such as rectangular or cylindrical tiles by various fabrication methods, including automated punching and stamping. Any suitable metal capable of being plastically formed using standard sheet metal forming techniques is a potential candidate for encapsulation of ceramic tiles to produce armor. Titanium, aluminum, and magnesium alloys have all been successfully employed and it is predicted that other metals such as niobium, tantalum, copper, chromium, nickel and zirconium, would also work well.

US2013284005 titled “Seam Protected Encapsulated Array” describes a similar idea, where adjacent tiles are protected by casting a metal around and over the tiles or by using a seam protector, which is a metallic honeycomb arrangement of cells into which ceramic tiles may be inserted.

GB1211489 titled “Composite Ceramic Armor” describes ceramic tiles protected by metal backing plates having flanges or lips covering tile free edges thereof.

US2002178900 titled “Armor with In-Plane Confinement of Ceramic Tiles” describes an armor component comprising ballistic plates covered with a fibrous wrapping material and a backing plate.

EP1522817 titled “A Composite Armor Plate and Ceramic Bodies for Use Therein” describes a composite armor plate for absorbing and dissipating kinetic energy from high-velocity projectiles, the plate comprising a single internal layer of pellets which are bound and retained in plate form by an elastic material, substantially internally within the clastic material, such that the pellets are bound in a plurality of spaced-apart rows and columns, the pellets being made of ceramic material, and the pellets being substantially fully embedded in the elastic material so that the pellets form an internal layer, wherein the solidified material and the plate are elastic, and wherein, a majority of each of the pellets is in direct contact with six adjacent pellets in the same layer to provide mutual lateral confinement there between, each of the pellets being characterized by a body having a substantially regular geometric cross-sectional area and first and second end faces, each of the end faces projecting from the body and having an outwardly decreasing cross-sectional area wherein the height of the end face disposed substantially opposite to an outer impact receiving major surface of the plate is less than 15% of the length of the diameter of the pellet body from which it projects.

EP2095055 titled “Composite Armor and Method for Making Composite Armor” describes a composite armor panel and a method for making the armor, which in one embodiment the armor consists of a plurality of ceramic tiles individually edge-wrapped with fiber or edge-wrap fabric, which are further wrapped with a face-wrap fabric, and encapsulated in a hyper elastic polymer material permeating the fabric and fibers, with a back plate adhered to the encapsulated tiles. In one embodiment the hyper elastic polymer is formed from an MDI-polyester or polyether prepolymer, at least one long-chain pol yester polyol comprising ethylene/butylene adipate diol, at least one short-chain diol comprising 1,4-butanediol, and a tin-based catalyst.

U.S. Pat. No. 5,686,689 titled “Lightweight Composite Armor Describes a Lightweight Composite Armor that Includes an Integrally Formed Matrix Block”. The matrix block includes a generally planar back, a plurality of intersecting ridges extending from the front of the planar back, and fillets provided at the junctures between the planar back and the ridges and at the juncture between the ridges. The matrix block thus forms a pattern of open topped cells. An energy absorbing ceramic body is located in each cell. Individual front plates sized to fit in the open top of each associated cell in mating contact with the ceramic body and provided with upstanding flanges around the periphery thereof are also provided. A weld around the periphery of the front plates between the flanges and associated tops of the ridges is provided. In this manner, impact by a projectile on one of these front plates substantially limits any damage to that one front plate and the underlying ceramic body leaving the remaining armor substantially undamaged. In accordance with the preferred embodiment, each ceramic body includes a concave surface adjacent the mating front plate. In addition, small gaps which exist between the cells and the ceramic bodies are filled with a ceramic-based grout. A polymer impregnated fabric is also provided at the rear of the planar back as desired. Ridges at the planar back may also be provided for stiffening the planar back.

### SUMMARY OF THE INVENTION

A first aspect of the invention is directed to an element for armor plating comprising a tile and a metal cover bonded to the ceramic tile by an adhesive; the tile comprising a plate having an in-plane shape that is quadrilateral or hexagonal comprising a front face and a back face, and a plurality of side pieces there around, and the metal cover comprising a central face and two or three side panels extending from edges of the central face; the central face and two or three side-panels comprising a single piece of metal sheet having two or three side panels folded substantially perpendicularly to the central face to fit over a face and selected sides of the tile to thereby individually confine said tile.

Preferably the side pieces extend from alternating edges of the central face of the cover and extend over alternate sides of the tile.

Optionally, the in-plane shape of the tile is substantially rectangular, wherein adjacent tiles have covers with a central face and either long or short sides, so that an array may be formed wherein all the front or back faces of the tiles are covered, and there is one layer of metal cover interposed between each pair of adjacent sides.

In some embodiments, the in-plane shape is substantially square, wherein the adjacent plates have covers comprising a central face and a pair of side panels on opposite sides attached to opposite edges of the central face, so that an array of tiles may be formed wherein the all front or all the back faces of the tiles are covered, and there is one layer of metal cover interposed between each pair of adjacent edges of adjacent tiles.

Optionally, the face of the tile and the central face of the metal cover are curved.

In some embodiments, the tile and the central face of the metal cover are domed.

Optionally, the metal cover is attached to the strike face of the tiler.

Alternatively, the metal cover is attached to the back face of the tile.

In one embodiment, two covers are attached to the ceramic tile. one covering the back face and a first set of alternate sides and the other covering the front face and a second set of alternate sides, such that all the faces and the sides of the ceramic tile are covered.

In some embodiments, the metal cover is adhered to the ceramic tile with a polymer adhesive.

Typically, the polymer adhesive is selected from the group comprising thermoplastics, thermosets and elastomers.

Typically, the tile comprises a ceramic selected from the group comprising AI₂0₃, ALN, SiC, TiB₂ B₄C, TiC, Si₃N₄ and BN.

In some embodiments, the tile further comprises a metallic phase.

In some embodiments, the cover comprises at least one metal selected from the group comprising iron, aluminum, magnesium or titanium.

In some embodiments, the cover is stamped out of a sheet of metal and is then folded.

A second embodiment is directed to a piece of armor plating comprising an array of tiles covered with metal covers such that the sides of adjacent tiles are separated by at least one metal side of at least one cover.

A third embodiment is directed to a piece of armor plating comprising an array of tiles having substantially quadrilateral in-plane shapes, each tile covered with a metal cover comprising a face and two side pieces on opposite sides, such that when adjacent tiles are rotated to bring into tessellating alignment, the sides of adjacent tiles are separated by a layer of metal cover.

Typically, the tiles are oblong, and the cover of one tile covers the face thereof and the long sides, whereas the cover of an adjacent tile covers the face thereof and the short sides, such that a tessellation of tiles creates a ceramic continuous surface divided into tiles that are each covered with a metal cover, having edges folded over to separate each pair of adjacent edges with a layer of metal.

A fourth embodiment is directed to an array of tiles comprising hexagonal faces and thin rectru1gular sides; each tile being covered on one hexagonal face by a metal cover having protruding side pieces that are folded substantially perpendicularly to the hexagonal face, such that each thin rectangular side of each tile is separated from a thin rectangular side of an adjacent tile by a layer of metal.

A fifth embodiment is directed to a metal cover for a single tile, comprising a central face corresponding to the face of the tile, and side pieces extending from edges of the central face of the cover and folded perpendicularly thereto, each side piece for covering a side of the tile.

Typically, the central face is a polygon having 4 or 6 sides and the side pieces extend from alternate faces.

Optionally, the metal cover is fabricated by deep drawing from a metal sheet.

Alternatively, the metal cover is fabricated by stamping from a metal sheet. Optionally an intermediary layer is disposed between the face of the tile and the metal cover.

The intermediary layer may be selected from the group comprising polymer adhesives, metals and glass reinforced polymers.

The shielding element comprising a ceramic tile and metal cover of the invention may be used together with other ballistic impact resistant materials, such as woven Kevlar layers, HDPE sheets and the like.

### BRIEF DESCRIPTION OF THE FIGURES

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in, the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a tile with a substantial rectangular in-plane shape and a pair of corresponding metal covers comprising a central face and side pieces extending from edges thereof and folded substantially perpendicularly thereto, a first metal cove with side pieces attached to short ends of a central face, and a second metal cover with side pieces attached to long ends of the central face.

FIG. 2 shows a tile with a substantial square in-plane shape tile in accordance with another embodiment of the invention and a corresponding cover with a substantially square face and a pair of side pieces attached to opposite edges thereof, folded to be substantially perpendicular to the substantially square face.

FIG. 3 shows how a cover of FIG. 2 may be rotated through 90°, such that adjacent covers can cover adjacent tiles, with a side piece of a cover separating each pair of the adjacent tiles:

FIG. 4 shows a domed tile with a substantial hexagonal in-plane shape and a cover thereof;

FIG. 5 shows how covers can be rotated through 60° so that adjacent covers may be coupled into an array for creating an array of tiles such that each pair of adjacent tiles is separated from each other by a side piece extending from one cover.

FIG. 6 shows how an array of irregular quadrilaterals may be tessellated to cover a surface.

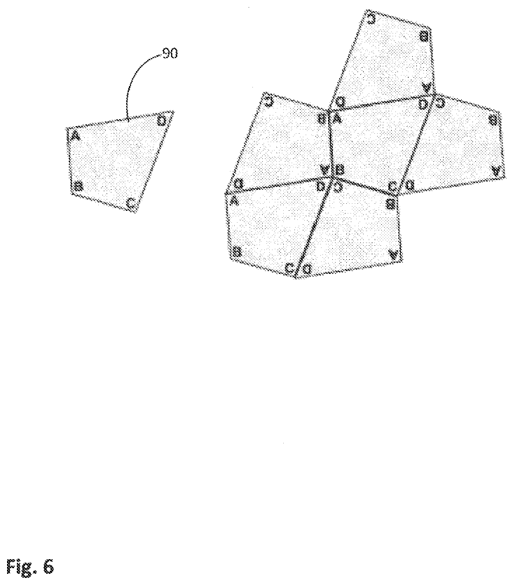

### DESCRIPTION OF EMBODIMENTS

To prevent cracks propagating from comers of elements of ceramic armor, ideally the armor scales or tiles are disc shaped. However, the coverage provided by an array of close-packed disks is only about 73% and to provide continuous protection, such discs need to be laid in two layers. Instead, scale armor typically comprises ceramic tiles whose in-plane shape is either hexagonal or quadrilateral, typically rectangular or square, since these tessellate to cover surfaces without leaving gaps. Usefully, the comers of the hexagon or oblong (rectangle or square) are rounded to prevent crack propagation so it will be appreciated that the term “substantially” is used to refer to a shape having rounded comers. Furthermore, the term “in-plane shape” refers to the projection of the tile, or the corresponding flat shape that is tessellated. However, in practice, ballistic tiles may be concave or convex to better follow topography of the surface being protected. Furthermore, sometimes the outer surface of the strike face is domed, which has been found to be useful in providing improved impact resistance.

Further, to protect corners of such tiles and to prevent cracks propagating from one tile to an adjacent tile, the tiles may be covered with metal.

WO2009045584 titled “Method for Producing Armor Through Metallic Encapsulation of a Ceramic Core” describes scales for armor comprising ceramic tiles that are encapsulated in metal which is bonded thereto by diffusion bonding. It will be appreciated that this manufacturing technique is very expensive.

It has surprisingly been found that merely covering the strike face or the back face of the tiles with a metal cover bonded thereto with a simply adhesive, typically a polymer, and folding flaps or side pieces extending from the central face of the metal cover around the edges of the tiles, so that each tile is individually confined, helps absorb the energy of ballistic impact and prevents cracks in one tile spreading to its neighbors, making it possible to locally replace damaged tiles to provide armor plating, particular for vehicles and ships.

It will be appreciated that coating only one side of the ceramic tiles, requires only half as much metal as would be required to coat both sides. This is more economical and much easier than full encapsulation. This also simplifies production and provides favorable acoustic transmission to the structure.

Additionally, the proposed technique uses only half as much metal between adjacent tiles which are separated by only one and not two layers of metal.

It is proposed to stamp out a metal half net consisting of a central face surrounded by tabs on alternate edges. The tabs may then be folded up, substantially perpendicular to the central face to from a cover into which the tile may be fixed. In one embodiment, the metal cover is adhered to the tile with a polymer adhesive which may be thermoplastic or thermoset or an elastomer. The cover may be fit over the front surface or the back surface of the tile.

Optionally an intermediary layer is disposed between the face of the tile and the metal cover.

The intermediary layer may be selected from the group comprising polymer adhesives, metals and glass reinforced polymers.

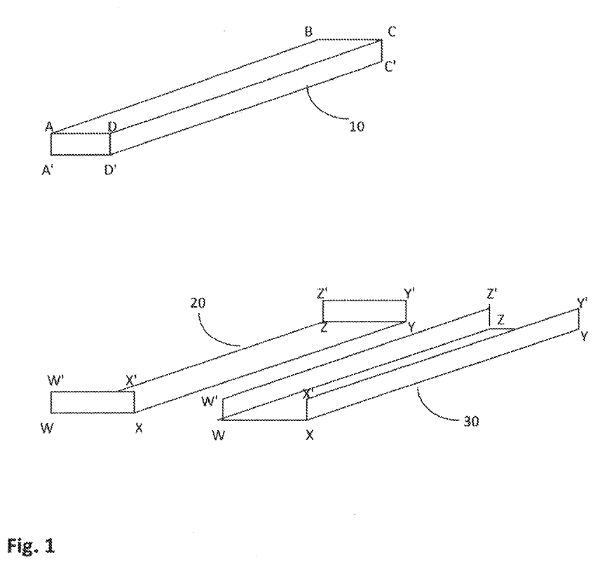

With reference to FIG. 1, a rectangular ceramic tile 10 is shown having a front face ABCD with edges AB, BC, CD and DA. There is a back face A′B′C′D′ and sides AA′BB′, BB′CC′. CC′DD′ and DD′AA′. Also shown is a cover 20 consisting a central face WXYZ and surrounding side pieces WW′XX′ and YY′ZZ′. A second cover 30 with face W′X′Y′Z′ and sides XX′YY′, WW′ZZ′ is also shown.

An array consisting of a tessellation of tiles 10 may be covered with alternating first covers 20 and second covers 30, having short sides W′WX′X (Z′ZY′Y) or long sides W′W′Z′Z (X′XY′Y) attached to central faces WXYZ. In this way, a continuous metal cover is formed which could be positioned as a backing for the array of tiles 20 or alternatively, on the strike face thereof. A metal side piece extending from the edge W′WX′X (Z′ZY′Y) (W′W′Z′Z) (X′XY′Y) attached to central faces WXYZ of a cover is folded down and separates adjacent tiles ABCD. As shown in FIG. 1, the tile 10 ABCD could be elongated, however the tile 10 could alternatively have a less elongated aspect ratio.

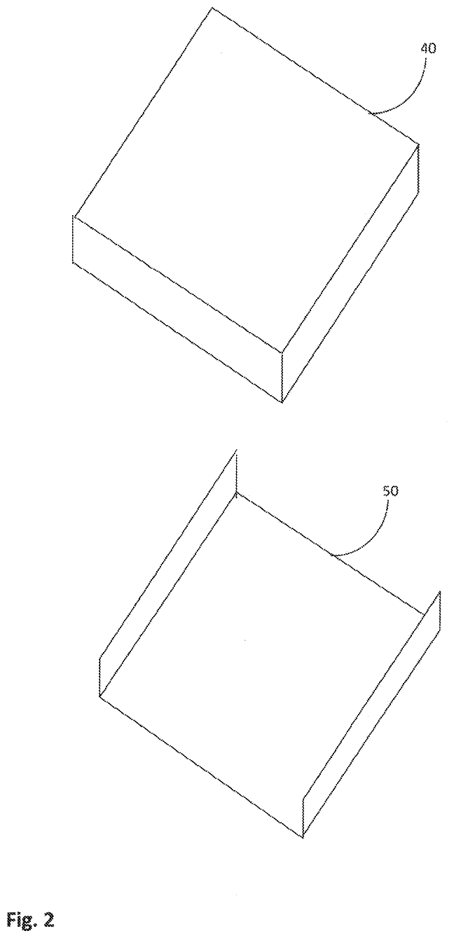

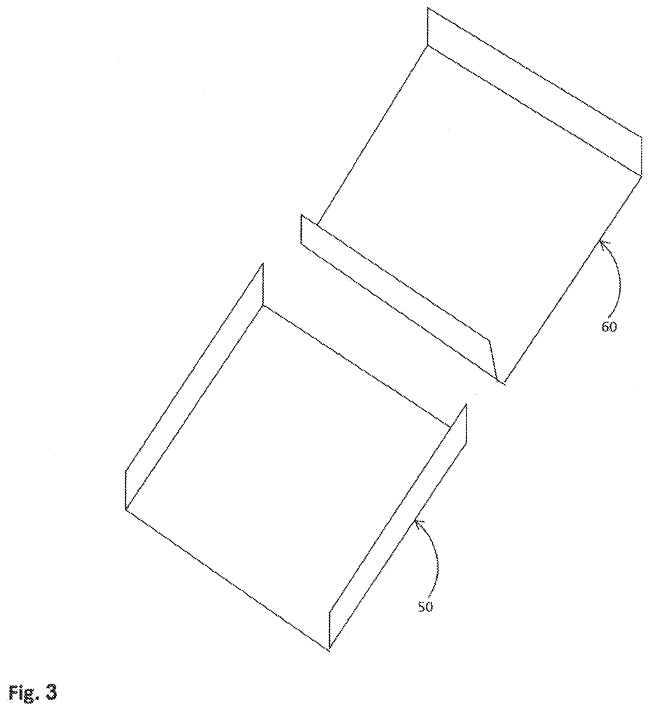

With reference to FIGS. 2 and 3, if the rectangular tile 40 ABCD is a square, the only one type of cover 50 is required to fully cover the array of tiles 40 and to provide metal separations between each pair of identical tiles in the array. With reference to FIG. 3, the cover 50 is rotated 90° to provide a cover 60 suitable for covering an adjacent tile, whilst ensuring that each edge between adjacent tiles is protected by one layer of metal.

The metal covers 20, 30, 50, 60 may be fabricated from steel, or, to obtain similar strength and corrosion resistance at reduced weight, from titanium. For light weight protection, aluminum could be used. Indeed, such covers could be stamped out of substantially any sheet metal or alloy, including, for example, iron, aluminum, titanium, cobalt, magnesium, tantalum, and their alloys.

The ceramic tiles 10, 40 could be fabricated from super hard material such as zirconia or tungsten carbide. However, permanent installations may be protected with thick layers of concrete. Amor plating is mostly used for protecting vehicles or boats, and a low-density ballistic ceramic, such as Al₂0₃, ALN, SiC, TiB₂ B₄C, TiC, Si₃N₄ or BN is preferred. It will be noted that so-called ceramic tiles need not be pure ceramic, and may include a metal binder phase, or ceramic fibers in an appropriate matrix. Furthermore, the ceramic tile may include a glassy phase. Additionally, the ceramic tile may be wrapped in fabric, such as Kevlar, or with a woven glass fiber mat impregnated with resin (prepreg), or with an intermediary metal layer prior to insertion into the cover.

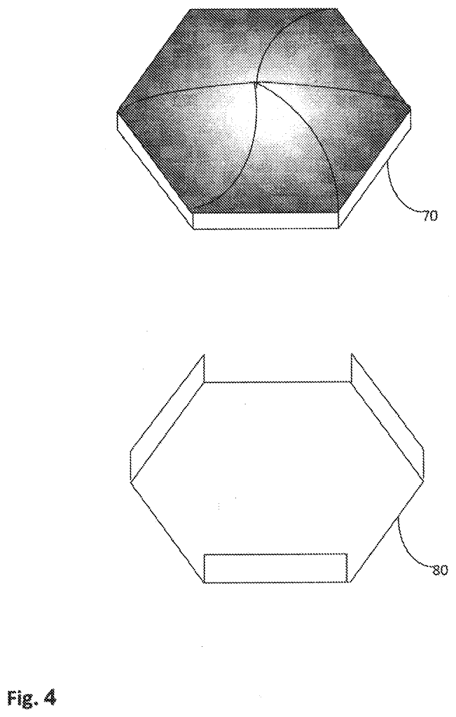

With reference to FIG. 4, in a further embodiment, a series of hexagonal tiles in hexagonal covers may be used to create a continuous array of tiles for providing ballistic protection. A ceramic tile having a hexagonal in-plane shape 70 and a corresponding hexagonal shaped metal cover 80 are shown.

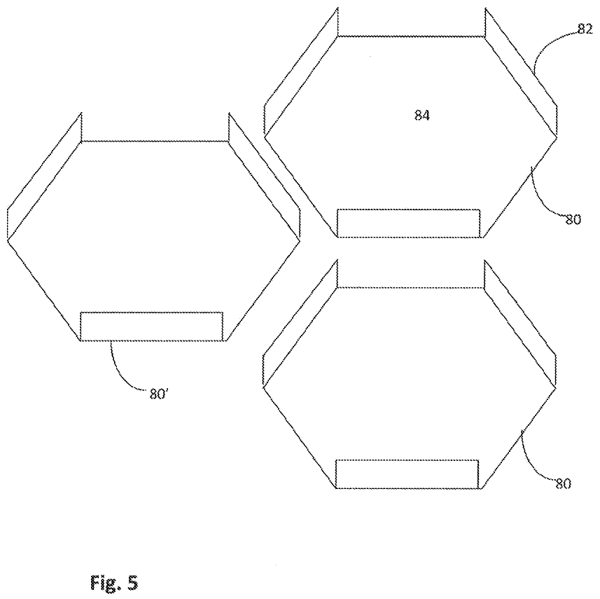

As shown in FIG. 5, adjacent metal covers having hexagonal faces 80, 80′ with side pieces 82 extending on alternate edges and folded up perpendicular to the hexagonal face 84 may be rotated through 60° and will tessellate to form a continuous array with side pieces 82 separating adjacent tiles 70 (FIG. 4) attached to the hexagonal faces 80. Although shown as a regular hexagon 70 in FIG. 4, hexagonal tiles need not be regular hexagons to tessellate. Nor need quadrilateral tiles by rectangular since, as shown in FIG. 5, irregular quadrilaterals 90 can be rotated and will still tessellate to completely cover a surface. Indeed, square based pentagons will tessellate and one could alternate a square based pentagon in a cover with a square based pentagon that has a backing plate but no side pieces, and obtain a similar effect.

Indeed, armor plating may be used to cover topographies of various shapes and not just flat surfaces.

It will be appreciated that while the in-plane shape of the tile is typically substantially quadrilateral or hexagonal, the tile need not be flat. In fact, typically the tile is domed, having a convex outer surface on the strike face. This is shown in FIG. 4 where tile 70 has a hexagonal in-plane shape, but is domed. This has been found to be effective in deflecting impact forces over the entire strike face. Furthermore, in some embodiments, customized tiles of the invention are used for covering and protecting vehicles having a surface with a defined topography. Whilst having standard tiles that are interchangeable has advantages, in some embodiments, the tile is fabricated to fit a specific position, and may be concave or convex to follow the topography of the underlying surface, for example.

The covers of the invention 20, 30, 50, 60, 80 placed over and around the edges of the ceramic tiles 10, 40, 70 prevent cracks propagating from one tile to an adjacent tile. They are easily produced and provide favorable acoustic transmission to the armor plating.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

In the claims, the word “comprise”, and variations thereof such as “comprises”, “comprising” and the like indicate that the components listed are included, but not generally to the exclusion of other components.

1. An element for armor plating comprising a ceramic tile and a metal cover bonded to the ceramic tile by an adhesive; the ceramic tile comprising a plate having an in-plane shape that is quadrilateral or hexagonal comprising two faces and four or six sides therearound, and the metal cover comprising a central face and a plurality of side pieces extending from non-adjacent edges of the central face, and folded substantially perpendicularly to the face to fit over a face and selected sides of the tile to thereby individually confine said tile.

2. (canceled)

3. The element of claim 1, wherein the in-plane shape is substantially rectangular, wherein adjacent tiles have a central face and either long or short sides, so that an array of the tiles may be formed wherein the central faces are covered, and there is one layer of metal cover interposed between each pair adjacent edges.

4. The element of claim 1, wherein the in-plane shape of the tile is substantially square, wherein each tile has a metal cover comprising a central face and a pair of side panels on opposite sides attached to opposite edges of the central face and folded to lie perpendicular thereto, so that an array may be formed comprising a layer of tiles covered with a continuous metal layer on one side, and further comprising a layer of metal interposed between all adjacent edges.

5. The element of claim 1, wherein the in-plane shape of the tile is substantially hexagonal, wherein each tile has a metal cover comprising a central face and three side panels extending from three non-adjacent edges of the central face and folded to lie perpendicular thereto, so that an array may be formed comprising a layer of tiles covered with a continuous metal layer on one side, and further comprising a layer of metal interposed between all adjacent edges.

6. The element of claim 1, wherein the face of the ceramic tile and the central face of the metal cover are curved.

7. The element of claim 4, wherein the face of the ceramic tile and the central face of the metal cover are domed.

8. The element of claim 1 wherein the metal cover is attached to the strike face of the tile.

9. The element of claim 1 wherein the metal cover is attached to the back face of the tile.

10. The element of claim 1, wherein two covers are attached to the ceramic tile, one covering the back face and alternate sides and the other covering the front face and alternate sides, such that all faces and sides of the ceramic tile are covered.

11. The element of claim 1, wherein the in-plane shape of the tile is substantially square, wherein each tile has a metal cover comprising a central face and a pair of side panels on opposite sides attached to opposite edges of the central face and folded to lie perpendicular thereto, so that an array may be formed comprising a layer of tiles covered with a continuous metal layer on one side, and further comprising a layer of metal interposed between all adjacent edges.

12. The element of claim 5, wherein said adhesive is a polymer adhesive selected from the group comprising thermoplastics, thermosets and elastomers.

13. The element of claim 1, wherein the face of the tile is protected with a metal, a polymer or fiber-in-polymer intermediary layer below the cover.

14. The element of claim 1, wherein the tile comprises a ceramic selected from the group comprising AI₂0₃, ALN, SiC, TiB₂ B₄C, TiC, Si₃N₄ and BN.

15. The element of claim 14, wherein the tile further comprises a metallic phase.

16. The element of claim 1, wherein the cover comprises at least one metal selected from the group of iron, magnesium, titanium and aluminum.

17. The element of claim 1, wherein the cover is stamped out of a sheet of metal and is then folded.

18. A piece of armor plating comprising an array of tiles, each tile being covered with a metal cover such that the sides of adjacent tiles are separated by at least one metal side piece of at least one cover.

19. A piece of armor plating comprising an array of tiles having substantially oblong in-plane shapes with long edges and short edges, each tile covered with a metal cover comprising a face and two side pieces on parallel sides, such that tiles with covers having long sides pieces attached to long edges of the face by folds, alternate with tiles having covers having central faces and a pair of short side pieces attached to short edges of the central face by a fold, such that each pair of adjacent tiles is separated by a metal side piece.

20. A metal cover for covering an individual ceramic tile of an array of ceramic tiles that comprises a piece of armor plating, the metal cover comprising a central face corresponding to the face of the tile, and side pieces extending from non-adjacent edges of the central face, folded to extend substantially perpendicular thereto for covering sides of the tile to separate said tile from an adjacent tile.

21. The metal cover of claim 20, wherein the central face is a polygon having 4 or 6 sides and the side pieces extend from alternate faces.

22. The metal cover of claim 20, being fabricated by deep drawing from a metal sheet.

23. The metal cover of claim 20, being fabricated by stamping from a metal sheet.
